(19) United States
(12) Patent Application Publication
(10) Pub. No.: US 2014/0303869 A1
(43) Pub. Date: Oct. 9, 2014

(54) SENSOR-BASED VEHICLE CONTROL METHODS

(71) Applicant: Yutaka Kanayama, Monterey, CA (US)

(72) Inventor: Yutaka Kanayama, Monterey, CA (US)

(21) Appl. No.: 14/362,894

(22) PCT Filed: Jan. 12, 2012
(86) PCT No.: PCT/US2012/021038

§ 371 Date: Jun. 4, 2014

(51) Int. Cl. G05D 1/02

(52) U.S. Cl. CPC G05D 1/021
USPC 701/93

(57) ABSTRACT

The novelty of this invention is that the vehicle's two degrees of freedom in motion is controlled by a single action of a driver. With this method, a driver can control a vehicle easily and intuitively. This invention might make it possible for impaired people to drive vehicles at their will for the first time. First, a sensor unit of a vehicle detects the Cartesian coordinates (x, y) that are specified by the driver. Second, a computing unit of the vehicle converts the coordinates (x, y) into a desired translation speed and a desired rotation speed, or into a desired translation speed and a desired curvature. Third, the motion control unit of the vehicle controls its motion using the desired translation speed and rotation speed, or the translation speed and curvature.

### TECHNICAL FIELD

This invention is related to the problem of whether there is a better method of driving automobiles and other vehicles than the currently available method using both leg and hands, especially for people with impairments or disabilities.

### BACKGROUND ART

We drive a car every day; we control steering with the steering wheel and control speed with the gas pedal and the brake. This operation needs our hands and feet. For a person with any level of disability, the operation of driving is difficult, or not possible. Furthermore, even people with no impairments often find it difficult to perform parallel parking and back-in parking. Electric wheelchairs are normally controlled by joysticks; however, people whose hand-arm coordination is impaired have difficulty in using this type of control.

These are some of the common problems drivers encounter when driving both cars and wheelchairs. The purpose of this invention is to solve most of these problems. This invention intends to provide a simple, safe, and intuitive vehicle-control method for all but the seriously disabled driver.

A prior art U.S. Pat. No. 8,068,953B2 offers a robot-control method that allows a robot to follow a human by sensing the distance and direction to the human. That vehicle's motion is controlled by a human action is the common ingredient with this invention. However, this invention is distinct in that a human action specifies a position (x, y).

### DISCLOSURE OF INVENTION

The basic idea of this invention is to control a vehicle's speed and steering in one simple human action with a help of sensors. Two variables are needed for the vehicle control. A driver's single finger motion can specify a position (x, y). Alternatively, an action could be that a driver shifts the center of gravity (x, y) of his or her body in a seat. He or she does not need to slide his or her buttocks; instead, he or she needs only to lean the upper body forward/backward and/or left/right.

If x changes, the vehicle speed changes; if y changes, the vehicle steering changes; if both x and y change at one time, both vehicle speed and steering change at one time.

A sensor system detects at one time the two variables that are necessary to respond and control the vehicle in accordance with the driver's wishes. Therefore, this method is much simpler than controlling an automobile using a driving wheel, an accelerator, or a brake, all of which use the driver's hands and legs.

As FIGS. 1, 2, 3, and 4 show, this invention can be embodied in these four algorithms in a vehicle that includes a sensor unit, a computing unit, and a motion-control unit. Each of these algorithms consists of three sets of steps, which are named A1, A2, B1, B2, C1, and C2, respectively. A1 and A2 are related to how a driver acts and how a sensor unit detects (x, y). B1 and B2 are related to how (x, y) is converted into (v, ω) or (v, κ), where v is translation speed, ω rotation speed, and κ curvature. C1 and C2 are related to how (v, ω) or (v, κ) control the motion of the vehicle.

A1. The Rectangular Sensor Unit Detects a Position (x, y) Specified by the Human's Hand.

With this method, a human's finger, or a pointing object held by a human's hand, touches a point on a rectangular sensor. In FIG. 5, the sensor unit has a rectangular plane (1), in which a Cartesian coordinate frame (2) is defined. This sensor plane can sense when and if it is touched, and the Cartesian coordinates (x, y) of the position (3) are returned. Notice that the coordinates (x, y) is obtained as a result of a human's single action. Such sensors are commercially available; for instance, a touchpad used in a laptop computer and a panel screen used in a smart phone use such sensors.

A2. The Sensor Unit Detects the Amount of Shift (x, y) in the Center of Gravity of the Human's Weight in a Seat.

In this method, the vehicle driver shifts the center of gravity of his or her body in the driver's seat. FIG. 6 shows a plan of one embodiment of sensing shifting amount in the center of gravity using pressure sensors embedded in a driver's seat (4). A coordinate frame (5) is defined in the seat. The seat is supported by three pillars (6), (7), (8), which are set on a floor; let their coordinates be (A, B), (A, −B), and (−A, 0), respectively, where A and B are positive constants. A pressure sensor is embedded in each pillar to detect the amount of weight applied downward. Let the detected weights by the three sensors be w(A, B), w(A, −B), and w(−A, 0), all of which are positive and variables over time. Using these weights, we calculate a “relative weight center” (x, y) of the driver. First, w_{front} is defined as:

w_{front}=[w(A, B)+w(A, −B)]/2 (EQ. 1)

w_{front} is the average of the two weights at the front of the seat. Then we compute x as:

x=[w_{front}−w(−A, 0)]/[w_{front}+w(−A, 0)] (EQ. 2)

Now we define y as follows:

y=[w(A, B)−w(A, −B)]/[w(A, B)+w(A, −B)] (EQ. 3)

These “relative coordinates” (x, y) are the output of this seat-sensor unit.

There is another embodiment to sense the shifting amount of a driver's center of gravity. FIG. 7 shows a driver's seat (9), in which a seat frame (10) is defined. The seat is supported by a pillar (11) at the seat's center set on a floor, in which a two-degrees-of-freedom torque sensor (12) is mounted. This sensor detects the torque tₓ around X axis and torque t_{y} around Y axis of the seat frame. Then, the torques are converted into shifting amounts, or “relative coordinates,” x and y using positive constants C and D as follows:

x=C t_{y} (EQ. 4)

y=D tₓ (EQ. 5)

Notice that the coordinates (x, y) is obtained as a result of a human's single action. “Relative coordinates” (x, y) discussed in this step A2 might not be proportional to the precise Cartesian coordinates of the center of gravity, but they work satisfactorily for the vehicle control purpose in this invention.

AA. Motion Modes of Car-Like Vehicles

How these two variables x and y obtained by Steps A1 and A2 are related to vehicle control? Consider practical vehicles such as automobiles, bicycles, tricycles, wheelchairs, shopping carts, and other vehicles for industrial use. These vehicles have the common features: they have at least one non-steerable wheel, whose direction is fixed to the vehicle-body direction. Normally their rear wheel(s) are non-steerable. As discussed in the following Section AA-1, those vehicles have only two-degrees-of-freedom in motion. This invention actually deals with vehicles that have this motion restriction, and the two-variable sensor output is necessary and sufficient to control vehicles as we wish.

There are two motion modes for vehicles with two-degrees-of-freedom in motion. The “omega mode” is discussed in Section AA-1 and the “curvature mode” in Section AA-2, respectively.

AA-1 The Omega Mode in Vehicle Motion Control

A vehicle used in the discussions about this invention is a two-dimensional rigid body (FIG. 8). We define the global coordinate frame (13) to describe the positioning and motion of this vehicle (14) on a global plane. On the vehicle a local (vehicle) coordinate frame (15) is defined. Its static positioning is formally described by a frame F as

F=((x_{R}, y_{R}), θ_{R}), (EQ. 6)

where x_{R} (16) and y_{R} (17) describe the position of the local frame origin, and the direction of the local X axis direction is θ_{R} (18), all in the global frame. Therefore, the two-dimensional motion M of this vehicle could be, in principle, represented by M=((dx_{R}/dt, dy_{R}/dt), dθ_{R}/dt), where t is time. The rotation speed dθ_{R}/dt is ω. However, the translation-speed part (dx_{R}/dt, dy_{R}/dt), can be better described as a vector with its value v (19) and local direction μ (20) with respect to the local frame (15).

M=(v, μ, ω) (EQ. 7)

An advantage of this motion representation is that the values v, μ, and ω are independent of any translation or rotation of the global coordinate frame (13). This equation shows that a two-dimensional rigid body has three-degrees-of-freedom in motion in the first place.

However, this invention actually deals with vehicles that have at least one non-steerable wheel (22), as FIG. 9 shows. Here, a differential-drive wheel architecture is adopted to describe a typical embodiment of this invention. If there are two non-steerable wheels, they must be coaxial. Typical examples are automobiles, bicycles, wheelchairs, and shopping cart. For those vehicles, because of the motion constraint due to the non-steerable wheels, the motion does not have the full three degrees of freedom. By taking the origin of the vehicle frame on the axle of the driving wheel(s), the direction p with respect to the local coordinate frame becomes 0 because the origin can move only in the wheel's moving direction. Therefore, the motion becomes

M=(v, 0, ω) (EQ. 8)

or, simply

M_{ω}=(v, ω) (EQ. 9)

with only two degrees of freedom, v and ω. From now on we stipulate that v>0 if the vehicle moves forward and v<0 if backward. This motion M_{ω} can represent any two-degrees-of-freedom motion, including a spinning motion, where v=0 and ω≠0. (Notice that the spinning motion cannot be executed by normal automobiles because of their wheel architecture) We call this motion mode the “omega mode” in contrast with another motion mode, the “curvature mode,” which is discussed in Section AA-2. Generally speaking, the omega mode is preferred for adoption in small spaces, where fine motion control of a vehicle should be handled with a relatively small translation speed.

Heavy vehicles on crawlers, such as bulldozers, cranes, and battle tanks, also have the two-degrees-of-freedom constraints in motion. Therefore, they can properly adopt this invention.

AA-2 The Curvature Mode In Vehicle Motion Control

Consider a set of omega-mode motions (v, ω), which specifically does not include spinning motions with v=0 and ω≠0. Namely, in this set of motions, if v=0, then ω=0. Under this restriction, we can compute the curvature κ of motion trajectory as follows:

κ=ω/v (EQ. 10)

because κ=dθ/ds=(dθ/dt)/(ds/dt)=ω/v, where s is the arc length of the vehicle trajectory. Because ω can be obtained by the relation ω=κv, vehicle motion can be represented by v and κ instead of v and ω:

Mₖ=(v, κ) (EQ. 11)

This motion mode is called “curvature mode.” An automobile is controlled in this mode; its speed v by the accelerator/brake and its curvature κ by the steering wheel. At a higher speed, this mode is generally more comfortable for drivers.

B1. The Computing Unit Computes Desired Motion (v_{d}, ω_{d}) in the Omega Mode Using (x, y).

Using the two variables (x, y) given by the sensor unit to control a vehicle is the heart of this invention. First, we consider a vehicle in the omega mode. Given x and y, our basic idea is that if x>0, the vehicle is to move forward, and vice versa; and, if y>0, the vehicle is to turn left, and vice versa. This concept is depicted in FIG. 10. More precisely, a typical embodiment can be formulated using an “unbiased monotone” function. We call a function f “unbiased” if f(0)=0. We also call a function f “monotone,” if the function satisfies the condition that if x₁<x₂, then f(x₁)≦f(x₂). An example of an unbiased monotone function is shown in FIG. 11. This sample function saturates as the absolute value of x becomes greater. In typical embodiment, the coordinate input (x, y) is converted into (v_{d}, ω_{d}) using unbiased monotone functions f₁₁ and f₁₂, as follows:

v_{d}=f₁₁(x) (EQ. 12)

ω_{d}=f₁₂(y) (EQ. 13)

In this conversion, only x determines v_{d} and only y determines ω_{d}. Although (EQ. 12) and (EQ. 13) demonstrate the basic principle of this invention, there could be some other useful embodiments. For instance, the sensitivity of steering f₁₂ can be lowered at a greater x in magnitude; in other words, the extent of steering is suppressed at a high speed.

B2. The Computing Unit Computes Desired Motion (v_{d}, κ_{d}) in the Curvature Mode Using (x, y).

Now we consider a vehicle in the curvature mode. Given x and y, our basic idea is that if x>0, the vehicle is to move forward, and vice versa; and, if y>0, the vehicle is to steer left, and vice versa. This concept is depicted in FIG. 12. This conversion is executed in a similar manner as discussed in Section B1; using unbiased monotone functions f₂₁ and f₂₂, one possible embodiment of this invention is that the coordinate input (x, y) is converted into (v_{d}, κ_{d}) as follows:

v_{d}=f₂₁(x) (EQ. 14)

κ_{d}=f₂₂(y) (EQ. 15)

As opposed to this simple mechanism, there could be another embodiment, in which a greater x in magnitude lowers the sensitivity of function f₂₂, as discussed in Step B1.

C1. The Motion-Control Unit Controls Vehicle Motion in the Omega Mode with (v_{d}, ω_{d}).

The desired motion (v_{d}, ω_{d}), in principle, can be given to the vehicle hardware to execute vehicle motion. However, if there exists discontinuity in either of the desired speeds, the vehicle hardware unit with a non-zero mass and a non-zero moment of inertia cannot fulfill the requirement. Therefore, as shown in FIG. 13, inserting feedback algorithms C1-1 between the desired speeds input and the vehicle hardware unit protects the vehicle motion hardware. First we describe Step C1-1, and then the step of controlling a wheeled vehicle C1-2:

C1-1 Feedback-Control Algorithms for the Omega Mode

To produce a continuous speed variable out of a not-necessarily continuous desired speed input, a simple embodiment is the use of a second-order feedback-control algorithm with damping. This algorithm produces a commanded translation speed v_{c} given a desired translation speed v_{d}:

dv_{c}/dt=a_{c} (EQ. 16)

da_{c}/dt=−k₁a_{c}+k₂(v_{d}−v_{c}) (EQ. 17)

where t is time, a_{c} acceleration, and k₁, k₂ positive constants. Another similar feedback system is needed to produce the commanded rotation speed ω_{c} given a desired translation speed ω_{d}:

dω_{c}/dt=u_{c} (EQ. 18)

du_{c}/dt=−k₃u_{c}+k₄(ω_{d}−ω_{c}) (EQ. 19)

where u_{c} is the time derivative of ω_{c}, and k₃, k₄ positive constants. Thus, an omega-mode motion (v_{c}, ω_{c}) is computed and is fed to the vehicle hardware unit.

C1-2 How a Vehicle can be Moved in the Omega Mode with (v_{c}, ω_{c})

FIG. 14 shows a differential-drive wheeled vehicle (14) equipped with two coaxial driving wheels (22) and one or two casters, which are not shown in the figure. A motion (v_{c}, ω_{c}) in the omega mode can be embodied by driving the left and right wheels at the following speeds, vₗ and vᵣ:

vₗ=v_{c}−Wω_{c} (EQ. 20)

vᵣ=v_{c}+Wω_{c} (EQ. 21)

where 2W is the distance between both driving wheels. For other wheel architectures, a person skilled in the art can easily find out its embodiment.

C2. The Motion-Control Unit Controls Vehicle Motion in the Curvature Mode with (v_{d}, κ_{d}),

Vehicle motion can be executed in the curvature mode as well. For the same reasoning stated in Step C1, it is more appropriate to insert feedback-control algorithms between the desired motion input (v_{d}, κ_{d}) and the vehicle hardware unit as shown in FIG. 15. First we describe Step C2-1, then the step of controlling a wheeled vehicle C2-2:

C2-1 Feedback-Control Algorithms for the Curvature Mode

This step is parallel to Step C1-1. The following second-order feedback-control algorithms convert desired speed/curvature (v_{d}, κ_{d}) into commanded ones (v_{c}, κ_{c}). Here v_{c} is commanded translation speed, κ_{c} commanded curvature, a_{c} acceleration, u_{c} the derivative of the commanded curvature, and k₅, k₆, k₇, k₈ positive constants:

dv_{c}/dt=a_{c} (EQ. 22)

da_{c}/dt=−k₅a_{c}+k₆(v_{d}−v_{c}) (EQ. 23)

dκ_{c}/dt=u_{c} (EQ. 24)

du_{c}/dt=−k₇u_{c}+k₈(κ_{d}−κ_{c}) (EQ. 25)

Thus, the resultant curvature-mode motion (v_{c}, κ_{c}) is computed and fed to the vehicle hardware unit. Even if (V_{d}, κ_{d}) is not continuous, (v_{c}, κ_{c}) becomes continuous.

C2-2 How a Vehicle can be Moved in the Curvature Mode with (v_{c}, κ_{c})

A relation ω_{c}=v_{c}κ_{c} holds from (EQ. 10). Therefore, for the differential-drive vehicles, the left and right wheel speeds in (EQ. 20) and (EQ. 21) becomes

vₗ=v_{c}−Wω_{c}=v_{c}−Wv_{c}κ_{c}=(1−Wκ_{c})v_{c} (EQ. 26)

vᵣ=v_{c}+Wω_{c}=v_{c}+Wv_{c}κ_{c}=(1+Wκ_{c})v_{c} (EQ. 27)

Thus, embodiment of vehicle motion in the curvature mode is also straightforward. For other wheel architectures, a person skilled in the art can easily find out its embodiment.

### BRIEF DESCRIPTION OF DRAWINGS

FIG. 1 illustrates how motion of a vehicle in the omega mode is controlled by a sensor unit that detects a human-specified position (x, y).

FIG. 2 illustrates how motion of a vehicle in the curvature mode is controlled by a sensor unit that detects a human-specified position (x, y).

FIG. 3 illustrates how motion of a vehicle in the omega mode is controlled by a sensor unit that detects the shifting amount (x, y) of the center of gravity of a human in a seat.

FIG. 4 illustrates how motion of a vehicle in the curvature mode is controlled by a sensor unit that detects the shifting amount (x, y) of the center of gravity of a human in a seat.

FIG. 5 shows how a human specifies a position in a rectangular sensor unit.

FIG. 6 shows the structure of a sensor unit with three pillars with pressure sensors, which detects the shifting amount of the center of gravity of a human sitting in a seat.

FIG. 7 shows how a two-dimensional torque sensor detects the shifting amount of the center of gravity of a human sitting in a seat.

FIG. 8 shows static positioning ((x_{R}, y_{R}), θ_{R}) and three-degrees-of freedom dynamic motion (v, μ, ω) of a vehicle in a global frame.

FIG. 9 shows restricted motion of a vehicle with only two-degrees-of freedom (v, ω).

FIG. 10 illustrates the concept that the X coordinate controls the sign of desired translational speed v_{d} and the Y coordinate controls the sign of desired rotation speed ω_{d}.

FIG. 11 is an example of unbiased monotone functions.

FIG. 12 illustrates the concept that the X coordinate controls the sign of desired translational speed v_{d} and the Y coordinate controls the sign of desired curvature κ_{d}.

FIG. 13 shows Step C1, how a vehicle in the omega mode is controlled by not-necessarily-continuous desired motion (v_{d}, ω_{d}).

FIG. 14 illustrates how a differential-drive type vehicle's motion (v_{c}, ω_{c}) is embodied by the speeds at the driving wheels.

FIG. 15 shows Step C2, how a vehicle in the curvature mode is controlled by not-necessarily-continuous desired motion (v_{d}, κ_{d}).

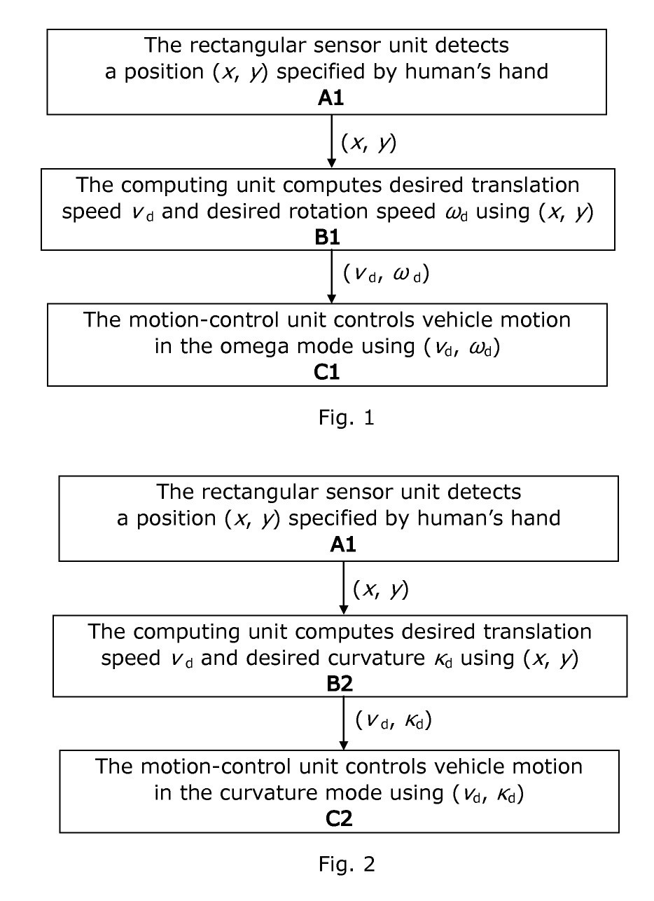

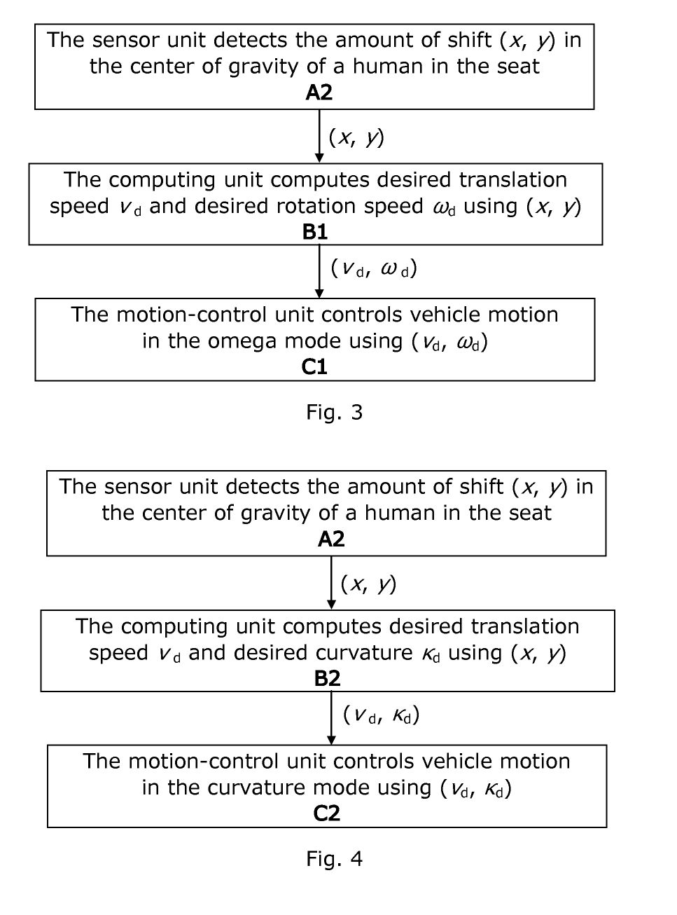

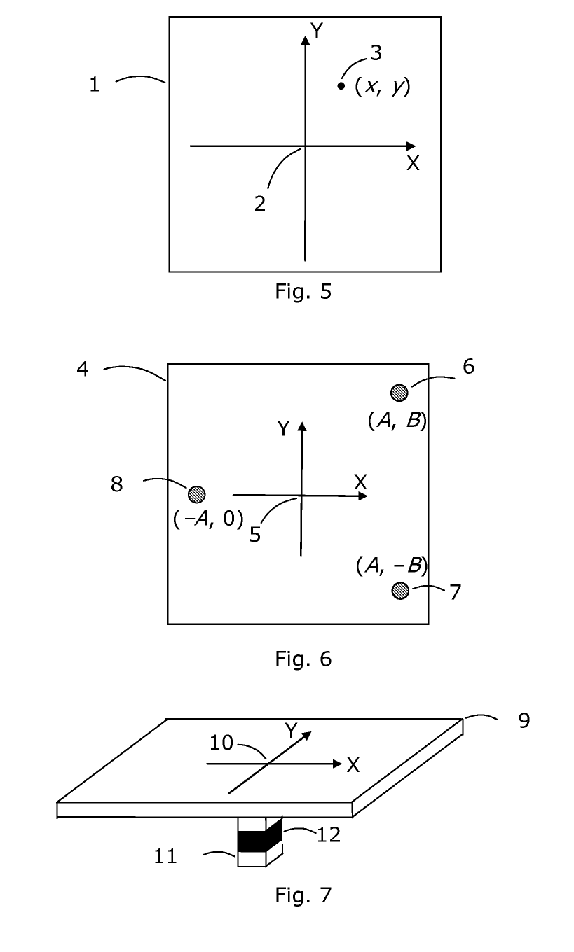

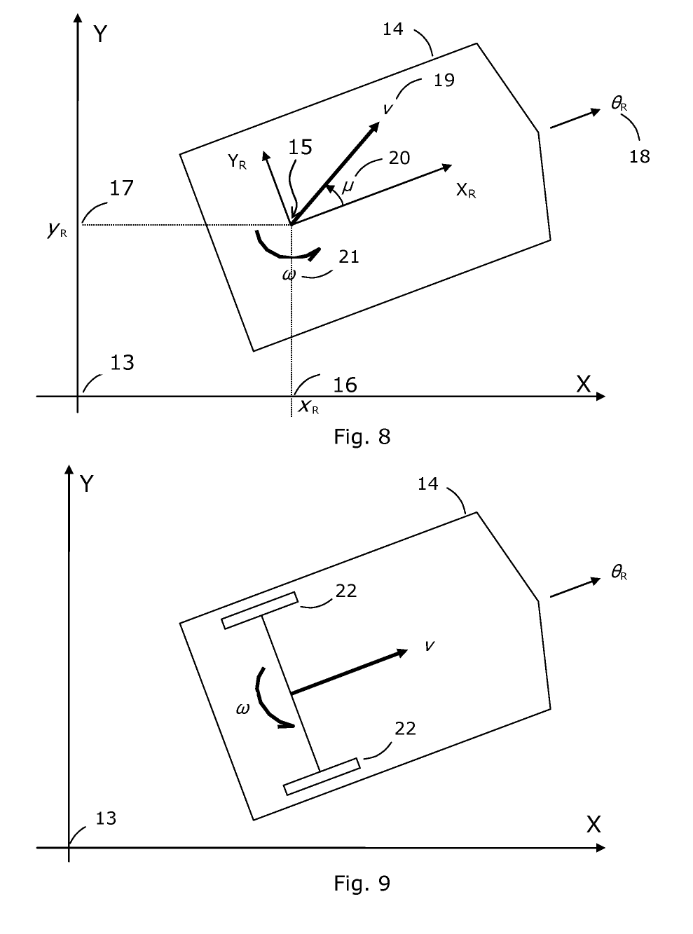

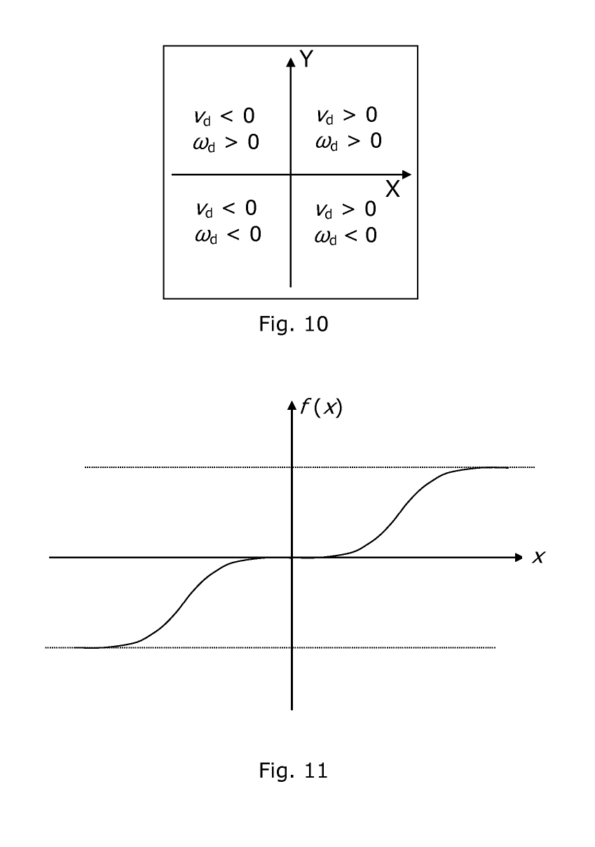

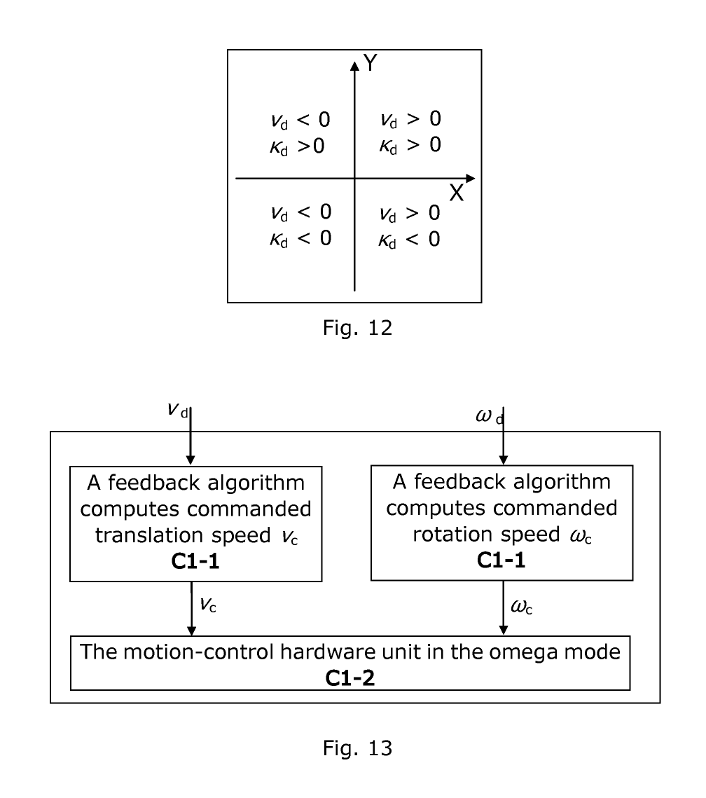

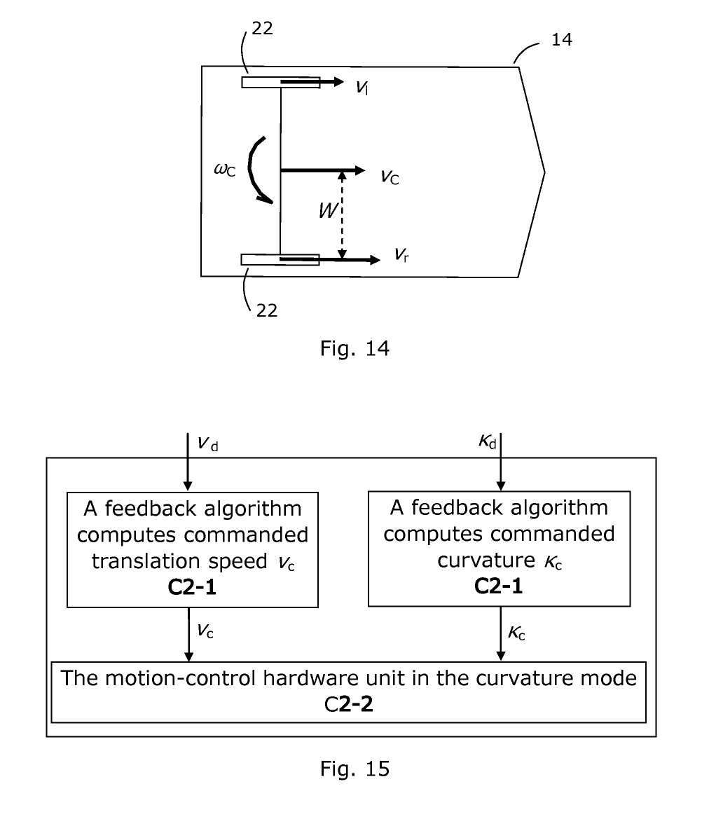

### BEST MODE FOR CARRYING OUT THE INVENTION

The best mode is to apply this invention to both present and future automobiles. This invention will tremendously help novice drivers, who often have difficulty executing parallel parking and back-in parking. Further, a moderately disabled person, who is not able to drive a car with an accelerator, brake, and steering wheels can easily drive a car enjoying great freedom for the first time. The method is so easy and safe that even a child could be allowed to drive in certain permissible situations.

Although present cars with internal combustion engines can use only the curvature-mode motions, a future car, such as an electric vehicle, can be controlled in the omega mode as well because its driving wheels can be independently energized. With the omega-mode capacity, a car easily makes fine and safe movement in a tight space; a car equipped with a sensor unit to detect a human-specified position gives our concept of driving a new dimension.

A car that can switch its motion mode between the two possesses a great advantage. The driver comfortably adopts the curvature mode at a higher speed, and he or she switches to the omega mode at a low speed in a tighter space.

### INDUSTRIAL APPLICABILITY

(1) A wheelchair can be equipped with a sensor unit to detect the amount of shift in the center of gravity in the seat to control itself using either the omega mode or the curvature mode. Weight shifting is much easier for everyone. Further, this application will tremendously help physically impaired people and allow them more freedom than they have enjoyed with existing technology. In the wake of electric vehicles, the effectiveness of the present invention will be sharply enhanced and will blur the existing boundaries of what automobiles and wheelchairs can do.

(2) This invention can typically be applied to the control of a vehicle by a person in it. However, another manner of application is possible: the person who drives the vehicle is NOT in it. A person outside a vehicle holds a sensor unit, which sends (x, y) to the vehicle. Or, a person is sitting on a seat outside the vehicle, while its sensor unit in the seat detects the amount of shift (x, y) in the center of gravity and sends it to the vehicle. One of the advantages of this embodiment is that the driver outside the vehicle might be in a better position to seeing the whole surroundings to make a better decision about moving a vehicle.

(3) This invention makes the control of the following vehicles easier, finer, and more intuitive: (i) Heavy industrial and construction vehicles. (ii) Plastic toy model cars, airplanes, helicopters, and virtual-vehicles in video games. Normal practice is to control those vehicles with two objects, which are buttons, levers, wheels, posture of a remote controller, and so forth. This invention does not need those anymore. (iii) Vehicles propelled with crawlers, such as bulldozers, cranes, and battle tanks.

(4) Thus, the invention will eventually be applied to a wide variety of vehicles that have not yet been imagined.

1. A method of controlling motion of a vehicle comprising the following steps:
its rectangular sensor unit detects the Cartesian coordinates (x, y) of a position specified by a human's hand;
its computing unit computes a desired translation speed and a desired rotation speed using the coordinates (x, y); and
its motion-control unit controls the vehicle's motion with the desired translation speed and the desired rotation speed.

2. A method of controlling motion of a vehicle comprising the following steps:
its rectangular sensor unit detects the Cartesian coordinates (x, y) of a position specified by a human's hand;
its computing unit computes a desired translation speed and a desired curvature using the coordinates (x, y); and
its motion-control unit controls the vehicle's motion with the desired translation speed and the desired curvature.

3. A method of controlling motion of a vehicle comprising the following steps:
its sensor unit detects the amount of shift (x, y) in the center of gravity of a human sitting in a seat;
its computing unit computes a desired translation speed and a desired rotation speed using the amount of shift (x, y); and
its motion-control unit controls the vehicle's motion with the desired translation speed and the desired rotation speed.

4. A method of controlling motion of a vehicle comprising the following steps:
its sensor unit detects the amount of shift (x, y) in the center of gravity of a human sitting in a seat;
its computing unit computes a desired translation speed and a desired curvature using the amount of shift (x, y); and
its motion-control unit controls the vehicle's motion with the desired translation speed and desired curvature.

5. A method of controlling vehicle motion by switching its motion mode between the omega and curvature modes.
